(19) United States
(12) Patent Application Publication
(10) Pub. No.: US 2014/0008557 A1
(43) Pub. Date: Jan. 9, 2014

(54) SOLENOID VALVE WITH FLAT CORE AND FLAT SPRING

(71) Applicant: ASCO JOUCOMATIC SA, Rueil Malmaison (FR)

(72) Inventor: Richard Vandamme, Cintray (FR)

(21) Appl. No.: 13/935,739

(22) Filed: Jul. 5, 2013

(30) Foreign Application Priority Data
Jul. 5, 2012 (FR) 1256485

(51) Int. Cl. F16K 31/06

(52) U.S. Cl. CPC F16K 31/06
USPC 251/129.15; 267/158

(57) ABSTRACT

A solenoid valve of the type with a flat core and a flat spring. The present invention related to a solenoid valve comprising a coil, a fixed core arranged inside the coil, a movable core arranged outside the coil, bearing a valve gasket, and a flat return spring to stress the movable core into a rest position, the solenoid valve being characterized in that the flat spring has variable stiffness, preferably bearing without embedding on corresponding surfaces of the solenoid valve.

### CROSS-REFERENCE TO RELATED APPLICATIONS

This nonprovisional application is a continuation of and claims priority to French Application No. 1256485, entitled “Solenoid Valve of the Type with Flat Core and Flat Spring”, filed Jul. 5, 2012 by the same inventor.

### BACKGROUND OF THE INVENTION

1. Field of the Invention

This invention relates, generally, to solenoid valves. More specifically, it relates to pneumatic solenoid valves, notably those used with programmable logic controllers (PLC) to control a compressed air supply. In an embodiment, the invention notably addresses the so-called miniature solenoid valves, that is to say those that fit within a volume typically less than 20 cm³.

2. Brief Description of the Prior Art

A solenoid valve conventionally comprises a coil excited by an electrical current and an element that can move under the effect of the magnetic field generated when the coil is powered, this movable element bearing a valve gasket. A preloaded return spring is provided to apply the gasket against a seat of the solenoid valve in the absence of excitation of the coil, in a so-called rest position, in order to seal a fluidic connection.

During the excitation of the coil, the movable element changes to a so-called adherence position and the return spring exerts on the movable element a return force which is greater than that exerted on this same element when the solenoid valve is not electrically powered.

The effort exerted on the movable element by the return spring must be perfectly controlled in order to ensure the seal-tightness of the closure in the rest position, despite the reverse effort generated by the fluid under pressure, without in any way preventing the movable element from being displaced when the coil is electrically powered. The spring must also return the movable element to the initial position, when the electrical power supply ceases.

There are two types of solenoid valve construction, one said to be with “adjustable movable core” and the other said to be with “flat movable core”.

The patent EP 1 536 169 B1 illustrates, notably in FIG. 1 of this prior patent, the first type of construction, in which the movable element takes the form of a core that is inserted deeply into the coil. In the solenoid valve illustrated in that patent, two flat springs are present, one of which is fitted in proximity to the valve gasket. This flat spring comprises a central ring defining a hole of relatively small diameter, linked by three flexible arms to a peripheral ring, as illustrated in FIG. 4 of that patent, which has been reproduced in FIG. 1A of the present application. The central ring is clamped between a screw which bears the valve gasket and the body of the movable core, and the peripheral ring is clamped between a securing ring and the body of a part used for coupling the solenoid valve with a fluid inlet and outlet. The spring is thus held in place by links with embedding. The relatively great difference in diameter between the central and peripheral ring allows great freedom in the choice of the form of the arms linking the central and peripheral rings, and the arms comprise portions that work by flexing generally in spiral arc form, each linked by a portion that works by twisting, oriented radially and being connected to the central ring.

The application WO 2011/095928 in the name of the applicant illustrates a solenoid valve of the second type of construction, with flat movable core. The valve gasket is borne by a movable core which is not inserted inside the coil but moves facing a fixed core arranged therein. A flat return spring is engaged around the movable core. The flat spring can exert a centring function. The difference in diameter between the central hole by which the spring is engaged on the movable core and the outer edge of the peripheral ring is relatively small.

The application WO 2008/028509 describes another exemplary construction of solenoid valve with flat movable core. The patent EP 1 350 999 B1 also discloses, in FIG. 1A of that patent, a construction with flat movable core.

EP 2 023 024 A1 discloses various examples of flat springs.

As indicated above, during the excitation of the coil the movable core is displaced towards the fixed core and the return spring is deformed. When the excitation ceases, the movable core must return to the position of rest, of closure of the orifice defined by the seat of the valve gasket.

In practice, a residual current, also called leakage current, may exist in the coil control circuit when the solenoid valve is required, according to the control set point applied, to return to the rest position, and the corresponding magnetic field generated by the coil tends to oppose the release of the movable core. This leakage current generally depends on the quality of the programmable logic controller used to control the solenoid valve, and a low tolerance of the solenoid valve to the leakage current demands the use of a more costly programmable logic controller with lower residual current.

Another phenomenon opposing the release of the movable core results from the magnetic remanence linked to the intrinsic characteristics of the materials used. The remanence level depends on the magnetic properties and reducing this level to facilitate the release of the movable core when the power supply to the coil has ceased generally involves using more efficient and more costly materials.

It is not beneficial to counter the harmful effect of the leakage current and of the magnetic remanence by increasing simply the stiffness of the spring, because this increase then makes the separation of the valve gasket more difficult during the excitation of the coil and, in addition, the stresses exerted by the spring at rest depend on the manufacturing tolerances of the parts; the greater the stiffness of the spring, the greater the risk of the residual mechanical stresses after assembly being significant and prejudicial to the correct operation of the solenoid valve.

One solution already employed in certain solenoid valves with adjustable movable core which are sensitive to this phenomenon of residual and/or remanence forces consists in using a spring with variable stiffness, capable of providing a limited stiffness in the rest position and an increased stiffness in the adherence position.

Conical springs with variable stiffness have thus been used in the solenoid valves with adjustable movable cores being produced by winding a metal wire so as to progressively vary the winding diameter.

A solution involving a flat spring with variable stiffness is also possible in the case of a solenoid valve with adjustable movable core, by virtue of the difference in diameter that can exist between the central and peripheral rings, because of the mounting of the spring on the adjustable core through the small diameter hole of the central ring.

By contrast the known flat springs with variable stiffness used on solenoid valves with adjustable movable core are unsuited to use on solenoid valves with flat movable core, given the smaller difference in diameter between the central and peripheral rings.

Moreover, it is not easy to reduce the diameter of the portion of the movable core on which the flat spring is engaged, because such a reduction may reduce the expanse of ferromagnetic material of the movable core facing the fixed core and, correlatively, the attraction force exerted by the coil. Furthermore, the valve gasket is often double-sided and the fixed core has an internal channel passing through it linked to an exhaust, and the fixed core has to be able to serve as seat for the valve gasket in the adherence position.

Consequently, the known solenoid valves with flat movable core all use flat springs with constant stiffness, for example such as that illustrated in FIG. 1B or in FIGS. 3A and 3B of the patent EP 1 217272 B1.

It has moreover also been proposed to use springs with variable stiffness in so-called proportional solenoid valves, in which the nonlinearity of the effort of the spring opposes the nonlinearity of the electromagnetic effort of the coil, in order to generate a substantially constant resultant force.

Accordingly, what is needed is an improved solenoid valve with flat movable core. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved solenoid valve with flat movable core and flat spring is now met by a new, useful, and nonobvious invention.

The present invention aims to further refine the solenoid valves of so-called flat movable core construction, notably by allowing for operation with a relatively high leakage current and/or the use of materials exhibiting a relatively high magnetic remanence, without in any way diminishing the performance levels of the solenoid valve in terms of dependability, electrical consumption and manufacturing cost.

Thus, the subject of the invention, according to a first of its aspects, is a solenoid valve comprising:
a coil,
a fixed core arranged inside the coil,
a movable core arranged outside the coil, bearing a valve gasket,
a return spring to stress the movable core into a rest position, notably a position where an orifice of the solenoid valve is sealed by the valve gasket.

According to the invention, the return spring with which such a solenoid valve is equipped is a flat spring with variable stiffness. This spring may comprise a central ring, a peripheral ring and flexible arms linking these rings, comprising portions that work by flexing and others that work by twisting in an elongation of the spring, the central and peripheral rings preferably bearing without embedding on corresponding surfaces of the solenoid valve.

The invention is based on the observation that is possible, notably by avoiding links with embedding, to produce a flat spring with variable stiffness for a solenoid valve with flat movable core, despite the bulk constraints which limit the extent of the annular region comprising the deformable and elastic parts of the spring.

By virtue of the invention, it is possible to benefit from a return force of the movable core that is greater after the cessation of the electrical excitation of the coil, even in the presence of a residual power supply current and magnetic remanence of the materials used. The absence of embedding of the spring advantageously enables the latter to retain a relatively weak stiffness and thus ensure satisfactory operation, including when manufacturing tolerances apply.

The non-linearity of the stiffness of the spring makes it possible, in the rest position, for the effort exerted by the valve gasket on its seat to remain moderate and the return spring does not furthermore counter the separation of the valve gasket when the coil is excited.

Preferably, the portions of the arms that work by twisting are separated, in the radial direction, from the central ring and from the peripheral ring by one or more cut-out portions. Such an arrangement facilitates the deformation of the twist-flexible arms without excessively increasing the stiffness of the spring when maximum elongation is reached during the operation of the solenoid valve.

In an exemplary implementation of the invention, the spring comprises portions that work by twisting which have a semi-circular form. The spring comprises portions that work by flexing, preferably in the form of concentric or parallel segments. Such an arrangement makes it possible to obtain a good variability of the stiffness while also affording a good resistance to repeated deformations.

Certain portions that work by flexing can each be linked to the peripheral ring by a material bridge situated substantially at mid-length and others can each be linked to the central ring by two material bridges spaced apart from one another.

Preferably, the arms extend within an annular region of deformability of the spring, delimited radially by the hole of the central ring and the outer edge of the peripheral ring. This annular region preferentially occupies less than 80% of the surface of the full disk defined by the outer edge of the peripheral ring, or less than 0.8×¼ π D²ₑₓₜ in the case of a circular outer ring of diameter Dₑₓₜ.

The greatest dimension of the flat spring is, for example, less than or equal to 20 mm, even 15 mm, 11 mm, 10 mm, 7 mm or 6 mm.

The material bridges connecting to the central ring can be of a number greater than three, this number being for example equal to six. The difference in radius between the hole of the central ring and that of the outline of the peripheral ring may be less than the diameter of the central hole.

Two portions that work by flexing and two portions that work by twisting and linking these parts that work by flexing can together delimit a kidney-shaped opening, with closed outline. The portion that works by flexing, radially innermost, may be linked to the central ring by two material bridges spaced apart from one another, preferably respectively substantially at ¼ and ¾ of the length of said portion.

The spring may comprise portions that work by flexing, at least one of which extends, or each extending, angularly over more than 90°, notably between 90° and 110°, for example, substantially 100°, around the axis of the spring.

The spring may comprise a peripheral ring comprising a notch on its outer edge and a protuberance on its inner edge, opposite to the notch.

The flat spring advantageously exhibits a coefficient C of variability of its stiffness greater than or equal to 1.3, better 1.75, even better 1.9.

When the spring comprises a central ring, the greatest dimension, notably the diameter Dint, of the hole defined by the central ring, may be between 3 and 10 mm.

The greatest dimension of the spring, notably the outer diameter Dₑₓₜ, may be between 6 and 20 mm.

Another subject of the invention, according to another of its aspects, is a flat spring with variable stiffness, notably for a solenoid valve as defined above, comprising flexible arms comprising portions that work by flexing and others that work by twisting, the annular region defined between a central hole and the outer edge of the spring occupying less than 80% of the surface of the full disk defined by the outer edge of the spring.

The spring preferably comprises portions that work by flexing, preferably arranged in pairs and preferably concentric or parallel, linked at their ends by the portions that work by twisting, the latter preferably being semi-circular, the radially outermost portions that work by flexing preferably being linked to a peripheral ring, preferably by a material bridge situated at mid-length, and those that are radially innermost preferably being linked to a central ring, preferably by two material bridges.

Such a spring can advantageously be used in all the constructions where the annular region of deformability of the spring is limited for reasons of bulk, as is notably the case for a solenoid valve with flat movable core.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description of non-limiting exemplary embodiments thereof, taken in connection with the accompanying drawings, in which:

FIGS. 1A and 1B depict examples of conventional flat springs.

FIG. 2 is a schematic and partial longitudinal cross section of an exemplary miniature solenoid valve with flat movable core according to the invention.

FIG. 3 is a front view of an exemplary flat spring that can advantageously be used in the solenoid valve of FIG. 2.

FIG. 4 represents the trend of the return force as a function of the elongation of the spring, in the case of a flat spring with constant stiffness according to the prior art and of a flat spring with variable stiffness according to the invention.

FIGS. 5A-5E are views similar to FIG. 3 of variant embodiments of the flat spring.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

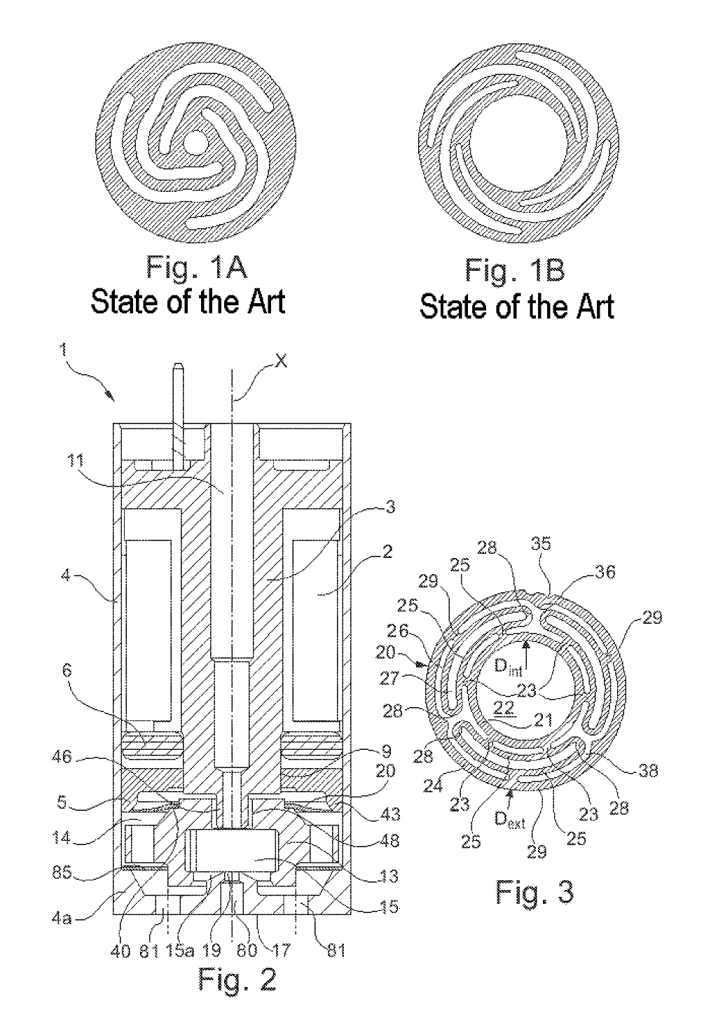

FIG. 2 shows an exemplary miniature solenoid valve according to the invention, conventionally comprising an electric coil 2, passed through by a fixed magnetic core 3 made of a ferromagnetic material, the assembly being for example housed as illustrated in a casing 4 extending longitudinally along an axis X, this casing 4 preferably also being made of a ferromagnetic material.

The solenoid valve 1 comprises a support ring 5 housed in the casing 4 and a seal gasket 6 arranged between the ring 5 and the coil 2 in the casing 4. This seal gasket 6 is applied on its greater diameter onto the radially inner surface of the casing 4 and by its smaller diameter to the fixed core 3.

The ring 5 has a central opening 9 passed through by the fixed core 3. The latter has an internal channel 11 passing through it internally and axially which enables the fluid to escape, in the rest configuration of the solenoid valve.

The solenoid valve 1 comprises a movable core 13 made of a ferromagnetic material, which can be displaced along the axis X in a housing 14 of the casing 4, under the effect of the magnetic field generated by the coil 2 when an electric current passes through it.

The movable core 13 bears a double-sided valve gasket 15 which is applied at rest by its inner face 15a against a seat 17, which delimits an orifice 19 connected to a source of fluid, for example compressed air.

A flat return spring 15 stresses the core 13 against the seat 17 in the absence of electrical excitation of the coil 2. The spring 20 is engaged on the core 13 and bears by its top face against the bottom face 43 of the ring 5.

The fixed core 3 is extended below by an end fitting 46 which is inserted into the movable core 13 and defines an orifice communicating with the internal channel 11. The end fitting 46 serves as a seat for the top face of the valve gasket 15 when the coil is powered and the movable core 13 is in the adherence position. When the valve gasket 15 of the movable core 13 rests against its seat 17, the housing 14 communicates with the internal channel 11.

The spring 20 has been represented in isolation, from the front, in FIG. 3.

It can be seen that the latter comprises a central ring 21 delimiting a hole 22 of relatively significant diameter Dᵢₙₜ, used for mounting on the movable core 13, at the height of the portion thereof that is engaged on the end fitting 46, above the valve gasket 15.

The spring 20 also comprises a peripheral ring 24 of diameter Dₑₓₜ, which is, for example, less than or equal to 10 mm. Dᵢₙₜ is, for example, greater than or equal to 4.9 mm.

Flexible arms link the central 21 and peripheral 24 rings, so as to confer an elastic deformability with variable stiffness upon the spring.

In the example illustrated, these arms are formed by etching a sheet of metal, for example spring steel, but other manufacturing methods can be used.

The arms comprise concentric portions 25 that work by flexing, which are linked together at their end by semi-circular portions 28 that work by twisting.

The expression “portion that works by flexing” should be understood to mean that, during the elongation of the spring, that is to say as the planes of the central and peripheral rings move apart along the axis X, this portion is deformed mainly by flexing to store elastic potential energy, the transversal section of this portion remaining substantially parallel to itself during the flexing.

The expression “portion that works by twisting” should be understood to mean that, during the elongation of the spring, this part is deformed mainly by twisting to store elastic potential energy. During twisting, the transversal section of the arm turns about an axis which is perpendicular to it.

The radially outermost portion 25 is linked, substantially at mid-length, by a material bridge 29, to the peripheral ring 24 and the radially innermost portion 25 is linked to the central ring 21 by two material bridges 23.

Preferably, as illustrated, all the bridges 23 are angularly equidistant around the axis of the spring, as are the bridges 29.

Each elastically deformable assembly formed by two portions 25 linked at their ends by portions 28 defines a kidney-shaped opening 27, of sealed contour.

Furthermore, it can be seen that, during the movement along a radius, the portions 28 are separated from the rings 21 and 24 by a cut-out portion 38 which extends on the one hand between the portions 25 and the rings 21 and 24 to the bridges 29 and 23 and on the other hand between the portions 28 belonging to two adjacent assemblies.

Thus, each cut-out portion 38 extends between the central 21 and peripheral 24 rings to the latter.

Each portion 25 extends, for example, angularly over approximately 100° about the axis of the spring, as illustrated. The bridges 23 are situated, for example, respectively at approximately ¼ and ¾ of the length of the radially innermost portion 25.

The spacing between the two adjacent portions 25, measured in the radial direction, is, for example, greater than the spacing between each portion 25 and the adjacent ring 21 or 24, as can be seen in FIG. 3. A plane passing through a material bridge 29 is, for example, as illustrated, a plane of symmetry for the angularly closest bridges 23.

A double notch 35 may be present as illustrated on the outer edge of the peripheral ring 24, its presence being linked to the manufacturing method. A protuberance 36 compensates on the opposite edge for the loss of material linked to the double notch 35, in the region thereof.

The spring 20 is mounted without embedding on the solenoid valve 1, the central ring 21 bearing freely against a shoulder 40 of the movable core 13, formed on its face turned towards the supporting ring 5.

The peripheral ring 24 bears against the bottom face 43 of the support ring 5. Thus, the spring 20 is not embedded at the level of the rings 21 and 24, and the latter bear over their entire circumference respectively on the movable core 13 and the ring 5.

A guiding washer 85 extends in the housing 14, around the movable core 13.

Axial passages 90 are produced through the movable core 13, to allow the fluid to pour more easily in the housing 14 and escape via the internal channel 11 when the solenoid valve 1 is not powered.

The casing 4 may have a bottom wall 4a extending at right angles to the axis X, through which a channel 80 passes which opens out via the orifice 19 facing the valve gasket 15 and via channels 81 that are connected on the one hand with the housing 14 and on the other hand with a device to which the fluid originating from the orifice 19 has to be sent when the movable core 13 is in the adherence position.

When the valve gasket 15 is applied at rest against its seat 17, the orifice 19 is blocked. When the solenoid valve 1 is electrically powered, and the valve gasket 15 is in the adherence position, the channels 80 and 81 are connected, whereas the channel 11 is closed by the valve gasket 15 which is applied against the end fitting 46. Gaskets which are not represented can ensure the seal-tightness of the connections.

When the coil 2 is powered, the magnetic flux circulates along the fixed core 3, passes into the movable core 13 via the axial air gap that exists between the two, and loops back to the fixed core 3 by circulating through the radial air gap between the movable core 13 and the casing 4, then into the latter.

The ring 5 may be clamped in the casing 4 during the manufacturing of the solenoid valve, after the spring has been fitted, so as to suitably preload the spring 20.

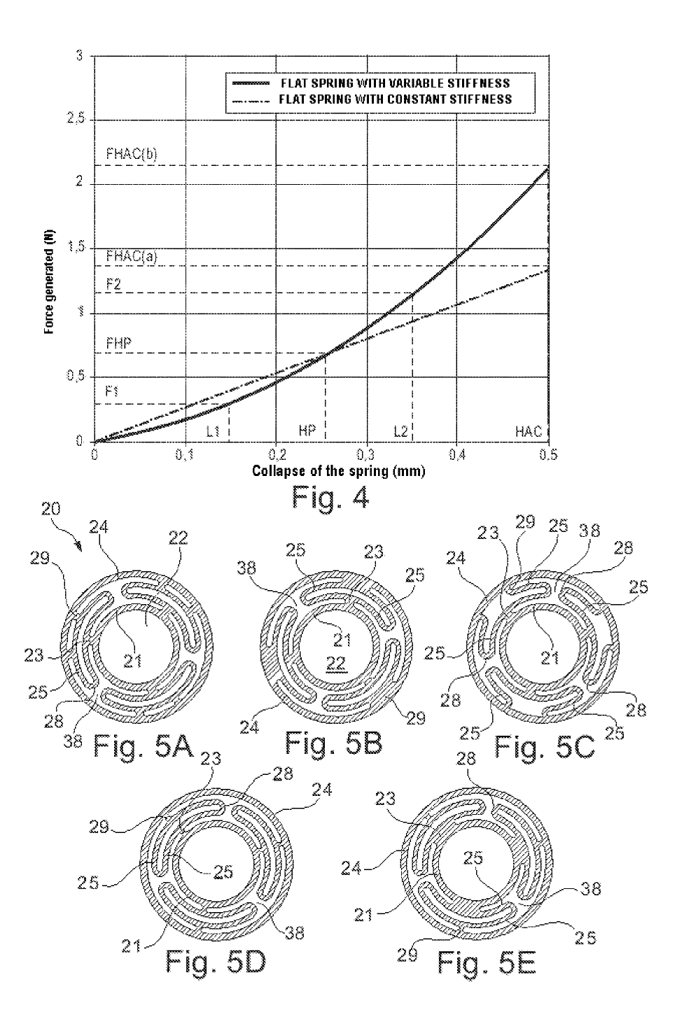

FIG. 4 shows the variation of the return force as a function of the elongation (also called collapse) of the spring, for a spring according to the invention as illustrated in FIG. 3 and a spring with constant stiffness according to the prior art, as illustrated in FIG. 1B.

The expression “spring with constant stiffness” should be understood to mean that the return force linked to the elongation of the spring is substantially linear over the range of operation of the spring in the solenoid valve, the coefficient of nonlinearity C as defined herein below being, for example, less than or equal to 1.1.

In a solenoid valve with flat movable core, notably as illustrated in FIG. 2, the travel in displacement of the movable core 13 between the rest and adherence positions is relatively small and typically between 0.15 mm and 0.3 mm.

The spring 20 is preloaded, that is to say its elongation at rest is not zero, being, for example, greater than or equal to 0.2 mm.

In FIG. 4:
HP denotes the height when fitted (solenoid valve with movable core in rest position),
HAC denotes the height after travel (solenoid valve with movable core in adherence position),
FHP denotes the force at height when fitted,
FHAC(a) denotes the force at height after travel (in the case of this spring with constant stiffness), and
FHAC(b) denotes the force at height after travel (in the case of the spring with variable stiffness).

A coefficient C of variability of the stiffness of the flat spring can be defined. This coefficient C is defined in Equation 1 by calculating the ratio between two stiffness values of the same spring, taken at two different collapse positions:

$$C = \frac{R 2}{R 1} = \frac{F 2 b - F 2 a}{L 2 b - L 2 a} / \frac{F 1 b - F 1 a}{L 1 b - L 1 a}$$

where R1 is the instantaneous stiffness coefficient in position L1, R2 is the instantaneous stiffness coefficient in position L2, L1 is the position corresponding to 30% of the defined maximum collapse (spring slightly compressed), L2 is the position corresponding to 70% of the defined maximum collapse (spring strongly compressed), L1a=L1−10% of the defined maximum collapse, L1b=L1+10% of the defined maximum collapse, L2a=L2−10% of the defined maximum collapse, L2b=L2+10% of the defined maximum collapse, F1a is the effort of the spring in the position L1a, F1b is the effort of the spring in the position L1b, F2a is the effort of the spring in the position L2a, and F2b is the effort of the spring in the position L2b.

The defined maximum collapse is equal to the collapse of the spring, between the spring when flat as manufactured (zero elongation) and the collapse during adherence.

In the case of a constant stiffness, the coefficient of variability C is substantially equal to 1, as explained above.

Preferably, the value of the coefficient C for a flat spring according to the invention is greater than or equal to 1.3, better 1.75, even 1.9.

In the example illustrated in FIG. 4, C is equal to 1.897, with the following parameters:

L1=0.15 mm

L2=0.35 mm

L1a=0.1 mm

L1b=0.2 mm

L2a=0.3 mm

L2b=0.4 mm

F1a=0.17N

F1b=0.46 N

F2a=0.89 N

F2b=1.44 N

Thus, C=[(1.44−0.89)/(0.4−0.3)]/[(0.46−0.17)/(0.2−0.1)]=1.897

As can be seen on examining FIG. 4, the stiffness of the spring according to the invention is nonlinear, which enables the return force generated to be the same for a weak collapse compared to a flat spring with constant stiffness and greater for a greater collapse; thus the separation of the valve gasket from its seat when the coil is excited is not prevented and the spring guarantees the return of the core to the rest position when the coil ceases to be powered, despite the existence of possibly greater leakage current and/or magnetic remanence.

It is contemplated that the current invention is not limited to the foregoing example.

The arrangement of the material bridges linking the portions 25 to the rings 21 and 24 can be modified so that it is, for example, the radially innermost portion 25 which is linked to the central ring 21 by a single material bridge 23 and the radially outermost portion 25 which is linked to the peripheral ring by two material bridges 29, as illustrated in FIG. 5A, a spring for which, for example, C≈1.3.

The form of the portions 28 that work by twisting can be modified and no longer be semi-circular, being, for example, rectilinear and radial.

The portions 25 may no longer extend along circular arcs but along undulating lines, following a median line which is in circular arc form for example.

FIGS. 5B to 5E show other examples of flat springs that conform to the invention, for which values of the coefficient C are for example respectively equal to approximately 1.3, 1.3, 1.5 and 1.8.

It can be seen on examining FIG. 5C that the flexible arms may each comprise a portion 25 that works by flexing, linked to the central ring 21 by at least one material bridge 23, notably a single bridge situated at mid-width, two portions 28 that work by twisting, at each of the ends of this portion 25, for example of semi-circular form like the examples prescribed previously, these portions 28 being connected to two portions 25 that each work by flexing, these portions being connected to the ring 24 by a material bridge 29 at their end opposite to the corresponding portion 28.

The number of flexible arms could be reduced to 2 or increased to 4, for example.

The flat spring may have, in variants that are not illustrated, a non-circular central ring, of polygonal form for example, notably square or hexagonal.

When the central hole is of polygonal form, the portions that work by flexing may extend parallel to the sides of this hole.

The peripheral ring may also be non-circular, being for example polygonal, notably square or hexagonal.

The flat spring is preferably produced by etching metal flat stock but, as a variant, the flat spring may be obtained by other techniques, for example by laser cutting.

The flat spring is preferably produced in a constant thickness but, as a variant, certain regions may be produced with a variable thickness, for example to locally increase or reduce the stiffness or the resistance to repeated deformations. Thus, the portions that work by twisting may be produced with a smaller thickness, for example.

Various modifications can be made to the solenoid valve.

The solenoid valve may comprise more than one spring, as appropriate. The solenoid valve may, for example, comprise an additional spring to compensate for heat expansion in particular, this additional spring acting, for example, between the valve gasket and the movable core.

In a variant, the solenoid valve is multiple and comprises a plurality of flat springs to ensure the return of a plurality of respective independent movable cores, these springs belonging, for example, to one and the same part of the solenoid valve, as illustrated in FIG. 5b of the patent EP 1 350 999 B1.

The movable core may be produced with a different form, and in particular the face of the movable core situated facing the fixed core may have a tapered or staged void, as illustrated in FIGS. 7 and 7b of the application WO 2011/095928.

The casing may be produced otherwise and, for example, at least partially monolithically with the fixed core, as described in the application EP 1 217 272. The casing may be produced with an added-on bottom wall.

The spring may be fitted with play or with radial clamping in the casing and/or on the movable core.

The spring is preferentially used on miniature solenoid valves, with flat movable core, in on/off operation, but the spring as such may find applications on other solenoid valves, for example proportional or with adjustable movable core, and in other fields, notably in instrumentation.

When the nature of the device which uses the spring and/or the operating conditions permit, the flat spring according to the invention may be fixed with embedding, at the level of the central hole and/or of the outer edge.

The solenoid valve may comprise one or more permanent magnets, as disclosed in WO 2008/028509, so as to obtain a so-called double-pulse operation.

The solenoid valve may be produced without the internal channel passing through the fixed core, or with other fluidic arrangements.

Preferably, the rest position of the movable core of the solenoid valve corresponds to the closure of a fluid intake orifice; as a variant, this rest position corresponds to any other predefined fluidic communication state.

The fluid may be other than compressed air, and be another gas or a liquid.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween. The expression “comprising a” should be understood to be synonymous with “comprising at least one”.

What is claimed is:

1. A solenoid valve, comprising:
a coil;
a fixed core arranged inside the coil;
a movable core arranged outside the coil, bearing a valve gasket; and
a flat return spring to stress the movable core into a rest position, the flat spring having a variable stiffness.

2. A solenoid valve as in claim 1, the flat spring bearing without embedding on corresponding surfaces of the solenoid valve.

3. A solenoid valve as in claim 1, the spring comprising a central ring and a peripheral ring, the central and peripheral rings being linked by flexible arms comprising flexing portions and twisting portions, where the twisting occurs in an elongation of the spring.

4. A solenoid valve as in claim 3, the twisting portions being separated from the central and peripheral rings, in the radial direction, by one or more cut-out portions.

5. A solenoid valve as in claim 1, the flat spring comprising flexing portions arranged concentrically or in parallel.

6. A solenoid valve as in claim 1, the flat spring comprising twisting portions each linking two flexing portions.

7. A solenoid valve as in claim 6, the twisting portions having a semi-circular form.

8. A solenoid valve as in claim 6, comprising flexing portions arranged in pairs and linked at their ends by the twisting portions, a radially outermost aspect of a flexing portion being linked to a peripheral ring and a radially innermost aspect of a flexing portion being linked to a central ring.

9. A solenoid valve as in claim 8, the radially outermost aspect being linked to the peripheral ring by a single material bridge.

10. A solenoid valve as in claim 9, the single material bridge being situated at mid-length of the radially outermost aspect.

11. A solenoid valve as in claim 8, the radially innermost aspect being linked to the central ring by two material bridges spaced apart from one another, respectively substantially at ¼ and ¾ of the length of said radially innermost aspect.

12. A solenoid valve as in claim 1, the spring comprising flexing portions, at least one of which extending angularly over substantially 100° around the axis of the spring.

13. A solenoid valve as in claim 1, the spring comprising a peripheral ring comprising a notch on its outer edge and a protuberance on its inner edge, opposite to the notch.

14. A solenoid valve as in claim 1, the flat spring exhibiting a coefficient C of variability of its stiffness greater than or equal to 1.3.

15. A solenoid valve as in claim 14, C being greater than or equal to 1.75.

16. A solenoid valve as in claim 14, C being greater than or equal to 1.9.

17. A solenoid valve as in claim 1, the spring comprising a central ring, the greatest dimension of the hole defined by the central ring, being between 3 and 10 mm.

18. A solenoid valve as in claim 1, the greatest dimension of the spring being between 6 and 20 mm.

19. A solenoid valve as in claim 1, the spring comprising central and peripheral rings, an annular region defined between the hole of the central ring and the outer edge of the peripheral ring occupying less than 80% of the surface of a full disk defined by the outer edge of the peripheral ring.

20. A flat spring, with variable stiffness, for a solenoid valve having a coil, a fixed core arranged inside the coil, a movable core arranged outside the coil, bearing a valve gasket, and a flat return spring to stress the movable core into a rest position, the flat spring having a variable stiffness, the flat spring comprising:
flexible arms comprising portions that work by flexing and others that work by twisting, the annular region defined between a central hole and the outer edge of the spring occupying less than 80% of the surface of the full disk defined by the outer edge of the spring.

21. A flat spring as in claim 20, the portions that work by flexing being arranged in pairs and being concentric or parallel, being linked at their ends by portions that work by twisting, the latter being semi-circular, the radially outermost portions that work by flexing being linked to a peripheral ring by a material bridge situated at mid-length, and those that are radially innermost being linked to a central ring by two material bridges.

22. A flat spring as in claim 20, the flexible arms each comprising a portion that works by flexing, linked to the central ring by a single bridge situated at mid-width, two portions (that work by twisting, at each of the ends of this portion, of semi-circular form, these portions being connected to two portions that each work by flexing, these portions being connected to the ring by a material bridge at their end opposite to the corresponding portion.
